(19) United States
(12) Patent Application Publication
(10) Pub. No.: US 2017/0302714 A1
(43) Pub. Date: Oct. 19, 2017

(54) METHODS AND SYSTEMS FOR CONVERSION, PLAYBACK AND TAGGING AND STREAMING OF SPHERICAL IMAGES AND VIDEO

(71) Applicant: DIPLLOID INC., Oakville (CA)

(72) Inventors: Sean Geoffrey RAMSAY, Oakville (CA); Adam Russell Hunter, Toronto (CA); Demosthenes Kandylis, Toronto (CA)

(73) Assignee: DIPLLOID INC., Oakville (CA)

(21) Appl. No.: 15/244,467

(22) Filed: Aug. 23, 2016

Related U.S. Application Data
(60) Provisional application No. 62/323,254, filed on Apr. 15, 2016.

(51) Int. Cl. H04L 29/06; G06F 17/22; G06F 3/0484; G06F 3/16; H04N 5/232; G06F 3/0482

(52) U.S. Cl. CPC H04L 65/601; H04N 5/23238; G06F 17/2235; G06F 3/0482; G06F 3/04845; G06F 3/165; G06F 3/04842

(57) ABSTRACT

Methods and systems for the conversion, playback, tagging and streaming of spherical images or spherical image sequences are provided. High field of view images and videos can be converted into spherical images and spherical images sequences. These images and image sequences can be viewed on a display devices and hyperlinked tags and objects can be placed on the sphere within the video and linked to additional content.

### CROSS-REFERENCE TO RELATED APPLICATIONS

This application claims priority of U.S. provisional patent application Ser. No. 62/323,254 filed Apr. 15, 2016, which is incorporated by reference into this application in its entirety.

### TECHNICAL FIELD

The present disclosure relates to video and image systems and methods and, in particular, to systems and methods for conversion playback, tagging and streaming spherical images and video.

### BACKGROUND

There are a wide variety of imaging systems available for recording all or substantially all of a spherical field of view. These image systems can generate high field of view images. When videos and images are captured using such systems, conventional video players are limited in their ability to fully display the images or videos.

It is, therefore, desirable to provide systems and methods for converting, displaying, tagging and streaming of spherical and spherical image sequences.

### SUMMARY

Methods and systems for the conversion, playback, tagging and streaming of spherical images or spherical image sequences are provided. High field of view images and videos can be converted into spherical images and spherical images sequences. These spherical images and spherical image sequences can be viewed on a display device; hyperlinked tags and objects can be placed on the sphere within the video and linked to additional content providing an interactive environment for the user.

In some embodiments, a high field of view image or video can be converted into a spherical image or spherical image sequence and spherical coordinates can be assigned to the pixels in the images according to a cylindrical projection that can be individually aligned with an image plane of each image.

In some embodiments of the above-described methods, assigning the spherical coordinates to the respective pixels according to the cylindrical projection aligned with the image plane for that image can comprise assigning the spherical coordinates to the respective pixels according to a pre-calculated lookup table derived from the cylindrical projection. The spherical coordinates in the pre-calculated lookup table can include position adjustments for distortion correction in addition to being derived from the cylindrical projection. In some embodiments of the above-described methods, the cylindrical projection can be a Miller cylindrical projection.

In particular embodiments of the above-described methods, assigning the spherical coordinates to each pixel in each image can result in unique pixels each having a unique spherical coordinate and pixel groups, with each pixel group comprising a plurality of pixels whose spherical coordinates are identical. In such embodiments, using the spherical coordinates to assign colours to the pixel positions in the spherical image according to the spherical image template can comprise, for each pixel position in the spherical image that maps to a spherical coordinate assigned to a unique pixel, assigning the colour of that unique pixel to that pixel position in the spherical image, and for each pixel position in the spherical image that maps to a spherical coordinate assigned to the plurality of pixels in a pixel group, assigning to that pixel position in the spherical image a colour blended from the plurality of pixels in the pixel group. Such embodiments of the above-described method can further comprise, for each pixel position in the spherical image that maps to a spherical coordinate remaining unassigned to any pixel, assigning to that pixel position in the spherical image a colour determined by oversampling nearby pixel positions in the spherical image. In some embodiments, the methods can further comprise correcting each image for distortion. Each image can be one image in a video stream comprising a plurality of images.

In some embodiments, an image or video can be mapped to a notional sphere, a buffering area can be read into a processor readable memory and a smaller two dimensional area can be displayed to a viewer on the a display device. The two dimensional area can be repositioned around the notional sphere within the buffering area. As the two dimensional area is repositioned, the position of the buffering area can also be repositioned. The position of the two dimensional can be recorded for later playback of the recorded view. Hyperlinks can be placed on the notional sphere which can provided links to additional content to the viewer when the position of hyperlink is within the two dimensional area displayed to the viewer.

In some embodiments, a motion tracking algorithm can be used to track the location of an object in a spherical video or image sequence. The tracked object can be hyperlinked or another object such as a two dimensional (“2D”) model or three dimensional (“3D”) model can be inserted into the spherical video or image sequence allowing for additional effects, advertising or product placement.

In some embodiments, the video or image sequence can be streamed to a user device from a server as a series of individual frame image files. The frame files can be requested based on an associated recorded timecode captured by an internal timer during capture by an electronic device. In some embodiments an additional audio file can be captured. The timecode of the audio file can be cross referenced with the timecode recorded from the internal timer and associated to image files. This will allow for referencing of specific images or image sequences specific to an audio timecode.

In some embodiments, the system can comprise computer program products comprising tangible computer-usable media embodying instructions for carrying out the above-described methods, and computer systems for implementing the above-described methods.

In some embodiments, the system can comprise a portable electronic device further comprised of a support frame designed to be hand held, wherein the frame can be configured to support two lenses located on opposing sides of the frame, which can be held by hand, and where the lenses can have a field of view greater than 180 degrees, the lens facing in opposite directions along a singular optical axis.

Broadly stated, in some embodiments, a method can be provided for displaying at least one spherical image each image comprising a plurality of pixels, the method comprising: generating a notional sphere; receiving the at least one spherical image; associating each pixel of the at least one spherical image with spherical coordinates of the notional sphere; reading a buffering area being a portion of the spherical image into a processor readable memory; displaying on a display device a two dimensional area of the spherical image, the two dimensional area being an area smaller than the buffering area, the two dimensional area being associated to a first position on the notional sphere; repositioning the two dimensional area displayed on the display device within the buffering area to a second position on the notional sphere; repositioning the buffering area such that the display area is centered in the buffering area.

Broadly stated, in some embodiments, a method can be provided for displaying at least one spherical image each image comprising a plurality of pixels, the method comprising: generating a notional sphere; receiving the at least one spherical image; associating each pixel of the at least one spherical image with spherical coordinates of the notional sphere; displaying on a display device a two dimensional area of the spherical image, the two dimensional area being associated to a first position on the notional sphere; and repositioning the two dimensional area displayed on the display device within the at least on spherical image to a second position on the notional sphere.

Broadly stated, in some embodiments, the at least one spherical image can comprise a video image stream.

Broadly stated, in some embodiments, the method can further comprise reading a buffering area being a portion of the spherical image into a computer readable storage medium, the buffering area being an area larger than the two dimensional area; and repositioning the buffering area such that the display such that when the two dimensional area is repositioned the two dimensional area is centred in the buffering area.

Broadly stated, in some embodiments, the method can further comprise the step of recording one or more positions of the display window as a sequence of views to the computer readable storage medium.

Broadly stated, in some embodiments, the repositioning of the two dimensional area can be based on a pre-recorded sequence of views of the at least one spherical image.

Broadly stated, in some embodiments, the method can further comprise the steps of: selecting one or more points on the one or more spherical image; and associating and placing a first placed object at the one or more points.

Broadly stated, in some embodiments, the first placed object can comprise one or more of a tag, hyperlink, an image, a video, a video image sequence, a two dimensional model, a three dimensional model and an animation sequence.

Broadly stated, in some embodiments, the method can further comprise the step of linking the first placed object to additional content.

Broadly stated, in some embodiments, the additional content can comprise one or more of a second spherical image, an application, a linked image, a linked video, a linked video image sequence, and a URL based location.

Broadly stated, in some embodiments, the method can further comprise the step of displaying a previously placed object which is associated with a point on the notional sphere within the display area.

Broadly stated, in some embodiments, the method can further comprise the steps of: tracking the position of the one or more points in the one or more spherical image in each of the one or more spherical images, the one or more points representing a tracked object; and recording the position of the tracked object in each of the one or more spherical images in relation to the notional sphere.

Broadly stated, in some embodiments, the position of the first placed object can correspond to the position of the tracked object in each of the one or more spherical images.

Broadly stated, in some embodiments, a computer system can be provided for displaying at least one spherical image each image comprising a plurality of pixels, the computer system comprising: a digital electronic circuit; a display device; and at least one computer-readable storage medium operatively coupled to the digital electronic circuit, said at least one computer-readable storage medium containing a representation of at least one set of computer instructions that, when executed by said digital electronic circuit, causes the computer system to perform the operations of: generating a notional sphere; receiving the at least one spherical image; associating each pixel of the at least one spherical image with spherical coordinates of the notional sphere; displaying on a display device a two dimensional area of the spherical image, the two dimensional area being associated to a first position on the notional sphere; and repositioning the two dimensional area displayed on the display device within the at least on spherical image to a second position on the notional sphere.

Broadly stated, in some embodiments, the digital electronic circuit comprises one or more of a processor, a field programmable gate array (“FPGA”), and an application specific integrated circuit (“ASIC”).

Broadly stated, in some embodiments, the at least one spherical image can comprise a video image stream.

Broadly stated, in some embodiments, the digital electronic circuit can execute the at least one set of instructions to cause the computer system to further perform the operations of reading a buffering area being a portion of the spherical image into a computer readable storage medium, the buffering area being an area larger than the two dimensional area; and repositioning the buffering area such that the display such that when the two dimensional area is repositioned the two dimensional area is centred in the buffering area.

Broadly stated, in some embodiments, the digital electronic circuit can execute the at least one set of instructions to cause the computer system to further perform the operation of recording one or more positions of the display window as a sequence of views to the computer readable storage medium.

Broadly stated, in some embodiments, the operation of repositioning the two dimensional area can be based on a pre-recorded sequence of views of the at least one spherical image.

Broadly stated, in some embodiments, the digital electronic circuit can execute the at least one set of instructions to cause the computer system to further perform the operations of: selecting one or more points on the one or more spherical image on the notional sphere; and associating and placing a first placed object at the one or more points.

Broadly stated, in some embodiments, the first placed object can comprise one or more of a tag, hyperlink, an image, a video, a video image sequence, a two dimensional model, a three dimensional model, and an animation sequence.

Broadly stated, in some embodiments, the digital electronic circuit can execute the at least one set of instructions to cause the computer system to further perform the operation of linking the first placed object to additional content.

Broadly stated, in some embodiments, the additional content can comprise one or more of a second spherical image, an application, a linked image, a linked video, a linked video image sequence, and a URL based location.

Broadly stated, in some embodiments, the digital electronic circuit can execute the at least one set of instructions to cause the computer system to further perform the operation of displaying a previously placed object which is associated with a point on the notional sphere within the display area.

Broadly stated, in some embodiments, the digital electronic circuit can execute the at least one set of instructions to cause the computer system to further perform the operations of: tracking the position of the one or more points in the one or more spherical image in each of the one or more spherical images, the one or more points representing a tracked object; and recording the position of the tracked object in each of the one or more spherical images in relation to the notional sphere.

Broadly stated, in some embodiments, the digital electronic circuit can execute the at least one set of instructions to cause the computer system to further perform the operations of associating and placing the first placed object at the position of the tracked object in each of the one or more spherical images.

Broadly stated, in some embodiments, a method can be provided for converting a high field of view video from at least one camera into a spherical image sequence, the method comprising the steps of: deriving at least one image from the camera each image comprising a plurality of pixels, each image having an image timecode, wherein the at least one image defines an image plane representing a field of view from a unique point along an optical axis that is substantially perpendicular to the image plane; assigning a spherical coordinate on a notional sphere to each pixel in the at least one image according to a cylindrical projection aligned with the image plane for the at least one image; using the spherical coordinates to assign colours derived from the pixels to pixel positions in a spherical image according to a spherical image template, wherein the notional sphere is substantially centred on the unique point, and the image plane of the at least one image is substantially tangential to the notional sphere, and wherein the cylindrical projection is aligned with the image plane for the at least one image by a notional cylinder of the cylindrical projection having its cylinder wall substantially tangential to the image plane and its longitudinal axis intersecting the unique point along the optical axis; and storing each of the at least one images as an ordered directory in a computer readable storage medium.

Broadly stated, in some embodiments, the method can further comprise the steps of: capturing an audio signal in an audio channel the audio signal having a an audio timecode sequence; and associating the audio signal with the spherical image sequence by comparing the image timecode with the audio timecode sequence.

Broadly stated, in some embodiments, a computer system can be provided for converting a high field of view video from at least one camera into a spherical image sequence, the computer system comprising: a digital electronic circuit; at least one computer-readable storage medium operatively coupled to the digital electronic circuit, said at least one computer-readable storage medium containing a representation of at least one set of computer instructions that, when executed by said digital electronic circuit, causes the computer system to perform the operations of: deriving at least one image from the camera each image comprising a plurality of pixels, each image having an image timecode, wherein the at least one image defines an image plane representing a field of view from a unique point along an optical axis that is substantially perpendicular to the image plane, assigning a spherical coordinate on a notional sphere to each pixel in the at least one image according to a cylindrical projection aligned with the image plane for the at least one image, using the spherical coordinates to assign colours derived from the pixels to pixel positions in a spherical image according to a spherical image template, wherein the notional sphere is substantially centred on the unique point, and the image plane of the at least one image is substantially tangential to the notional sphere, and wherein the cylindrical projection is aligned with the image plane for the at least one image by a notional cylinder of the cylindrical projection having its cylinder wall substantially tangential to the image plane and its longitudinal axis intersecting the unique point along the optical axis, and storing each of the at least one images as an ordered directory in the computer-readable storage medium.

Broadly stated, in some embodiments, the digital electronic circuit can comprise one or more of a processor, an FPGA and an ASIC.

Broadly stated, in some embodiments, the digital electronic circuit can execute the at least one set of instructions to cause the computer system to further perform the operations of: capturing an audio signal in an audio channel the audio signal having a an audio timecode sequence; and associating the audio signal with the spherical image sequence by comparing the image timecode with the audio timecode sequence.

Broadly stated, in some embodiments, a method can be provided for streaming a video image sequence comprising a plurality of frame images from at least one server, the method comprising: selecting the video image sequence for viewing on a display device; requesting, via a communication interface, at least one frame image file based on timing information, each frame image file comprising at least one of the plurality of frame images; receiving, from the at least one server, the at least one frame image file; displaying, on the display device, the at least one frame image of the frame image file as a video; receiving subsequent frame image files from the at least one server and displaying, on the display device, the frame images of the subsequent frame image files.

Broadly stated, in some embodiments, the method can further comprise the steps downloading a manifest file which contains the timing information.

Broadly stated, in some embodiments, the method can further comprise the steps of receiving the audio signal file from the one or more server as a progressive download and playing the audio signal file based on coordinated timing information with the frame images.

Broadly stated, in some embodiments, the method can further comprise comprising the step of caching the at least one image file and the subsequent frame image files for displaying the images on the frame images on the display device.

Broadly stated, in some embodiments, the method can further comprise the step of buffering the at least one image file prior to displaying the frame images on the display device.

Broadly stated, in some embodiments, a computer system can be provided for streaming a video image sequence comprising a plurality of frame images from at least one server, the computer system comprising: a digital electronic circuit; a display device; a communication interface; and at least one computer-readable storage medium operatively coupled to the digital electronic circuit, said at least one computer-readable storage medium containing a representation of at least one set of computer instructions that, when executed by said digital electronic circuit, causes the computer system to perform the operations of selecting the video image sequence for viewing on a display device; requesting, via a communication interface, at least one frame image file based on timing information, each frame image file comprising at least one of the plurality of frame images; receiving, from the at least one server, the at least one frame image file; displaying, on the display device, the at least one frame image of the frame image file as a video; receiving subsequent frame image files from the at least one server and displaying, on the display device, the frame images of the subsequent frame image files.

Broadly stated, in some embodiments, the digital electronic circuit can comprise one or more of a processor, an FPGA and an ASIC.

Broadly stated, in some embodiments, the system can further comprising an audio output device, and wherein the digital electronic circuit executes the at least one set of instructions to cause the computer system to further perform the operations of receiving the audio signal file from the one or more server as a progressive download; and playing the audio signal file, via the audio output device, based on coordinated timing information with the frame images.

Broadly stated, in some embodiments, the digital electronic circuit can execute the at least one set of instructions to cause the computer system to further perform the operation of buffering the at least one image file prior to displaying the frame images on the display device.

Broadly stated, in some embodiments, the digital electronic circuit can execute the at least one set of instructions to cause the computer system to further perform the operation of caching the at least one image file and the subsequent frame image files for displaying the images on the frame images on the display device.

Broadly stated, in some embodiments, the digital electronic circuit can execute the at least one set of instructions to cause the computer system to further perform the operation of downloading a manifest file which contains the timing information.

Broadly stated, in some embodiments, a method can be provided for streaming a video image sequence comprising a plurality of frame images to a user device, the method comprising: receiving a request from the user device for a frame image file, the frame image file comprising at least one of the frame images, based on timing information; rendering the frame images of the frame image file based on a manifest file and saving a rendered frame image file to the computer readable storage medium; transferring, to the user device, the rendered frame image file; rendering frame images of subsequent frame image files based on the manifest file and saving subsequent rendered frame image files to the computer readable storage medium; and transferring, to the user device, the subsequent rendered frame image files.

Broadly stated, in some embodiments, the frame image file can comprise pre-rendered frames.

Broadly stated, in some embodiments, the method can further comprise the steps of: retrieving a frame image filename associated with the timing information from a data store; retrieving the frame image file associated with the frame image filename from a file server;

Broadly stated, in some embodiments, the file server can comprise a content delivery network.

Broadly stated, in some embodiments, the method can further comprise the steps of: transferring an audio signal file to the user device as a progressive download.

Broadly stated, in some embodiments, the rendering of the frame images can comprise reading rendering parameters from the manifest file.

Broadly stated, in some embodiments, a computer system can be provided for streaming a video image sequence comprising a plurality of frame images to a user device, the computer system comprising: a digital electronic circuit; at least one computer-readable storage medium operatively coupled to the digital electronic circuit, said at least one computer-readable storage medium containing a representation of at least one set of computer instructions that, when executed by said digital electronic circuit, causes the computer system to perform the operations of: receiving a request from the user device for a frame image file, the frame image file comprising at least one of the frame images, based on timing information; rendering the frame images of the frame image file based on a manifest file and saving a rendered frame image file to the computer readable storage medium; transferring, to the user device, the rendered frame image file; rendering frame images of subsequent frame image files based on the manifest file and saving subsequent rendered frame image files to the computer readable storage medium; and transferring, to the user device, the subsequent rendered frame image files.

Broadly stated, in some embodiments, the digital electronic circuit comprises one or more of a processor, an FPGA and an ASIC.

Broadly stated, in some embodiments, the frame image file can comprise pre-rendered frames.

Broadly stated, in some embodiments, the digital electronic circuit can execute the at least one set of instructions to cause the computer system to further perform the operations of: retrieving a frame image filename associated with the timing information from a data store; retrieving the frame image file associated with the frame image filename from a file server;

Broadly stated, in some embodiments, the file server can comprise a content delivery network.

Broadly stated, in some embodiments, the digital electronic circuit can execute the at least one set of instructions to cause the computer system to further perform the operation of transferring the audio signal file to the user device as a progressive download.

Broadly stated, in some embodiments, the operation of rendering of the frame images can comprise reading rendering parameters from a manifest file.

### BRIEF DESCRIPTION OF THE DRAWINGS

FIG. 1 is a flowchart depicting one embodiment of a method for converting a frame of high field of view video into a spherical image.

FIG. 2A is a perspective view depicting a first aspect of a prior art cylindrical projection to the Earth.

FIG. 2B is a perspective view depicting a second aspect of a prior art cylindrical projection to the Earth.

FIG. 3 is a flowchart depicting a method for assigning colours to image spaces in a spherical image according to a spherical image template.

FIG. 4 is an illustration of a notional sphere and a two dimensional area projected from the notional sphere.

FIG. 5 is an illustration of the notional sphere and a two dimensional area which can be repositioned on the notional sphere.

FIG. 6 is a series of illustrations of the notional sphere with reference points placed on the notional sphere.

FIG. 7 is a block diagram depicting a system for streaming image sequences.

FIG. 8 is a swim-lane diagram depicting a method of streaming image sequences.

FIG. 9 is a block diagram depicting a computer system.

FIG. 10 is a block diagram depicting a smartphone.

### DETAILED DESCRIPTION OF EMBODIMENTS

In an embodiment a high field of view or fisheye image or video can be converted to an equirectangular, cubic, 360 degree, spherical or panoramic image or image sequences. The image or individual image sequences from the video can be converted to a spherical image sequence. In the case of a video, individual frames of the video can be converted to spherical images and stored as image sequences. These image sequences can be buffered and loaded onto electronic devices random-access memory (“RAM”) or graphics processing unit (“GPU”) as an ordered directory. Audio can be captured in an audio channel independent from the image sequence. The audio can be associated with the images sequence using an appropriate timecode.

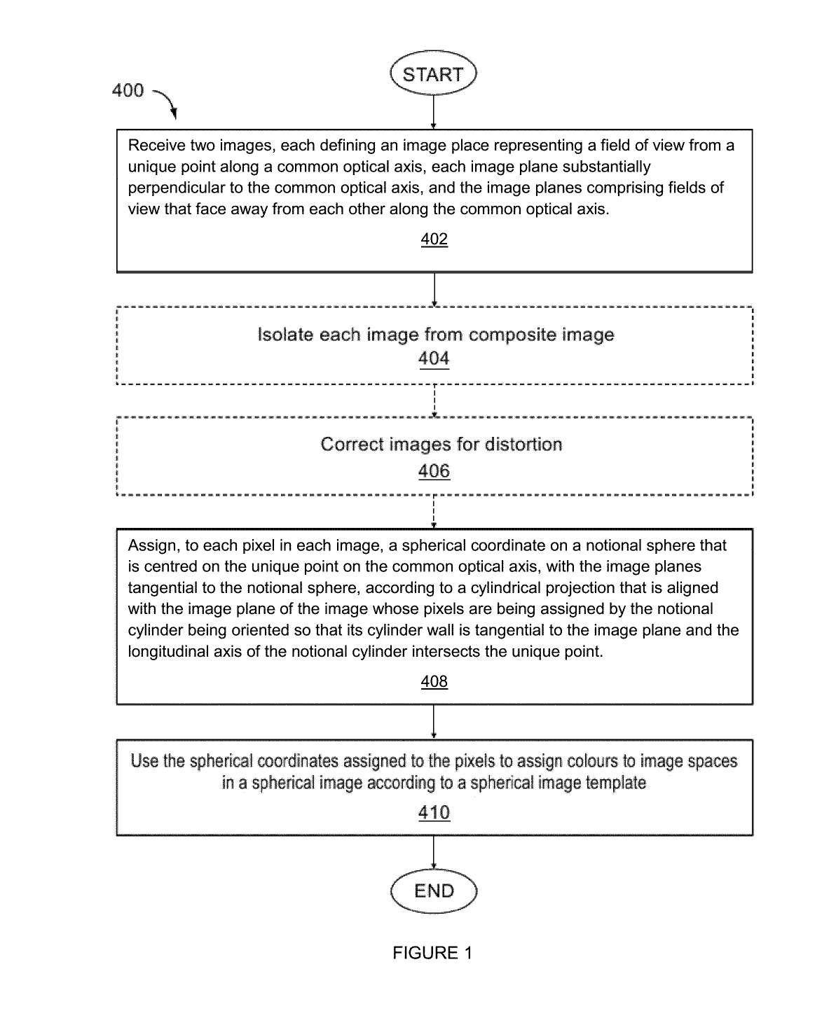

In an embodiment of a system to convert high field of view video into a spherical video image sequence, video can be captured using a fisheye or high field of view imaging apparatus. The video can be captured as individual image sequences where each image represents a frame of the video or the video may be captured in any of a number of video formats known to one skilled in the art. To convert the high field of view video a number of individual image frame can be derived from the video into an image sequence. These individual image frames can then be converted into spherical images. FIG. 1 is a flow chart showing representative method 400 for generating a spherical image, such as an equirectangular image. At step 402, method 400 receives at least one image. Although described in respect of a single set of at least one image, in this case two images, for ease of explanation, by repeated application method 400 can be used to process at least one synchronized video stream comprising an image sequence. In such cases, where there are two or more video streams comprising image sequences, the video streams comprising image sequences can be processed as separate video streams comprising image sequences or can be multiplexed into a single composite video stream comprising an image sequences. Where two or more images are multiplexed into a single composite image, method 400 can comprise optional step 404 of isolating each image from the composite image. Isolation step 404 need not involve actually decomposing the composite image, but can comprise of identifying the individual images based on known boundaries in the composite image.

At optional step 406, method 400 can correct the images for distortion where parameters of the imaging system associated with the high field of view images or video are known. A certain amount of distortion is inherent in any lens system, and generally increases as the field of view of the lens increases. Image distortion can fall into two categories: radial distortion and decentering distortion. Radial distortions are what make a straight line appear bent on wider angle lenses, and decentering distortion results from a focal plane array being incorrectly centered behind the principle point of the lens system. Distortion correction can involve adjusting the coordinate location of some or all of the pixels to a new coordinate location. Each pixel on an uncorrected image has an associated X and Y coordinate, and the correction for radial distortion and decentering distortion can be applied to each image to determine a new X and Y coordinate for the pixel that places it in the distortion corrected location.

To achieve the required distortion correction, a set of generalized adjustment parameters can be calculated for a particular type of image sensor (i.e. lens assembly and focal plane array) that captured the relevant image. Thus where all of the image sensors are of the same type, a single set of adjustment parameters is applied uniformly to all of the images. For commercially available lenses, the lens manufacturer may provide specifications that give a starting point for determining adjustment parameters for radial distortion. More precise adjustment parameters for radial distortion can be calculated using test images of targets that are easily identified in the images and located at known distances from the image sensors, to produce a dense point coverage on the images simultaneously. The same procedure can be used to determine adjustment parameters for decentering distortion.

If suitable adjustment parameters have been calculated for an image system used to capture the high field of view image or image sequence, these adjustment parameters can be applied to the images or image sequence. Uncorrected pixel positions would have a predetermined adjustment value that remaps the respective pixel to a corrected pixel position in the image to correct for the distortion, and the corrected pixel positions can be stored in the lookup table. Thus, for any given arbitrary pixel having coordinates (X, Y) in an uncorrected image, the conversion system can look up those coordinates in the lookup table and assign that pixel new coordinates (XC, YC) in the corrected image according to the lookup table.

The distortion correction step (step 406) can be omitted if the images received at step 402 are already sufficiently free of distortion for the subsequent steps to be carried out accurately. For example, the images can be received from an imaging system having onboard distortion correction capability. In some embodiments, as described in greater detail below, the distortion correction adjustment can be incorporated into a subsequent step (step 408) in the method 400.

At step 408, method 400 can assign, to each pixel in each image, a spherical coordinate on a notional sphere. The term “spherical coordinate” denotes a complete identification of a unique position on the surface of a notional sphere within the relevant reference frame and can be, for example, a set of Cartesian (X, Y Z) coordinates or a set of polar (r, e) coordinates.

Assigning the spherical coordinates to the pixels (step 408) can be carried out according to a cylindrical projection that is aligned with the image plane of the image whose pixels are being assigned. A cylindrical projection can be a type of map projection, which is a mathematical function that maps a position on the surface of a sphere to a position on a plane. The Mercator Projection, used to map the spherical surface of the Earth onto a rectangular planar map, is a well-known example of a cylindrical projection. Cylindrical projections are typically expressed in a form that takes a position on a sphere surface, for example latitude and longitude, and returns (x, y) values for the corresponding planar position. However, the notional sphere has an infinite number of points, whereas each image has a finite number of pixels. By reversing the relevant cylindrical projection, it is possible to determine, for a given planar coordinate, the position on the sphere that would be mapped to that planar coordinate according to that cylindrical projection.

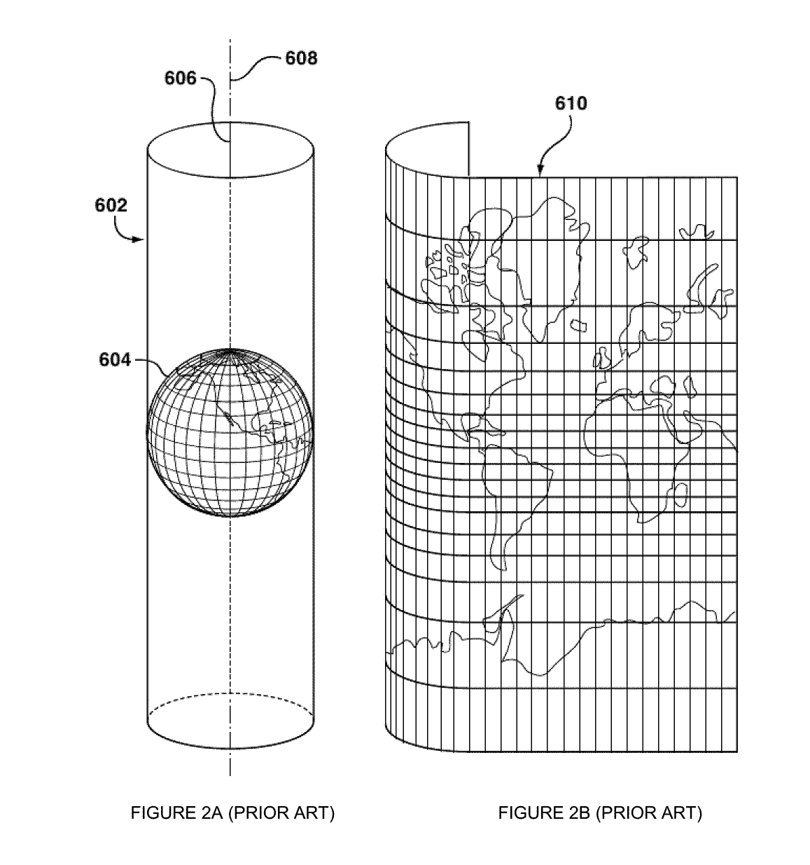

Reference is now made to FIGS. 2A and 2B, which show application of an representative cylindrical projection to the Earth. In overview, to obtain a cylindrical projection a notional hollow cylinder 602 can be arranged substantially tangentially to sphere 604, in this case the Earth, that is to be mapped (FIG. 2A). Points on sphere 604 are then projected onto notional cylinder 602 according to the formula for the particular cylindrical projection being used, and notional cylinder 602 can then be notionally “sliced” along notional line 606 parallel to its longitudinal axis 608 and notionally “unrolled” into plane 610 (FIG. 2B). The orientation of the notional cylinder relative to the sphere will affect how the points on the sphere are mapped to points on the notional cylinder and hence to points on the plane of the “unrolled” notional cylinder. Varying the orientation of the notional cylinder relative to the sphere will cause the same point on the sphere to be mapped to different positions on the plane.

Assignment of the spherical coordinates to the pixels of a particular image can be carried out according to a cylindrical projection that is aligned with the image plane of that image—in other words, the notional cylinder of the cylindrical projection can be oriented relative to the notional sphere to match the orientation of the respective image plane relative to the notional sphere.

As noted above, the image plane of each image can be substantially tangential to the notional sphere and substantially normal to a common optical axis pass through the image planes. The cylindrical projection can be aligned with the image plane when the notional cylinder is oriented so that its cylinder wall is substantially tangential to the image plane and the longitudinal axis of the notional cylinder intersects a unique point on the common optical axis.

When the cylindrical projection is so aligned, there can be a direct correspondence, without distortion, between positions on the image plane and positions on the cylinder wall. The image plane can be treated mathematically as if it were a part of the cylinder wall that has been “unrolled” from around the notional sphere. By treating the image plane as if it were part of the cylinder wall, the correspondence between planar positions on the image plane and spherical positions on the notional sphere can be determined according to the formula for the cylindrical projection. Since each pixel in the image corresponds to a position on the respective image plane, the spherical coordinates can then be assigned to the pixels in that image.

It should be noted here that as long as the notional cylinder is oriented so that its cylinder wall is substantially tangential to the image plane and the longitudinal axis of the notional cylinder intersects the unique point on the common optical axis, the pivotal position of the notional cylinder, relative to an axis normal to the image plane, is immaterial.

As noted above, each of the at least one images received at step 402 of method 400 (FIG. 1) can be images captured by the image sensors of a high field of view imaging apparatus system.

Referring again to FIG. 1, in a representative embodiment, at step 408 the spherical coordinates can be assigned to the respective pixels according to a pre-calculated lookup table derived from the cylindrical projection. The size, position and orientation of the image planes relative to one another and to the notional sphere are known and consistent and, hence, the spatial relationship of each pixel to the notional sphere is also known and consistent. Accordingly, the spherical coordinate representing the projection of each pixel from its respective image plane onto the surface of the notional sphere can be calculated in advance and stored in a lookup table, rather than being calculated each time an image is processed.

In some embodiments, the spherical coordinates in the pre-calculated lookup table used at step 408 can include position adjustments for distortion correction in addition to being derived from the cylindrical projection. Thus, for any given pixel, the associated spherical coordinates in the lookup table can represent the projection from the image plane onto the surface of a notional sphere of the distortion-corrected pixel position for that pixel.

In some embodiments, the cylindrical projection according to which the spherical coordinates are assigned to the pixels can be a Miller cylindrical projection. The inverse Miller projection, that is, the function that, for a given planar coordinate, gives the position on the sphere that would be mapped to that planar coordinate according to the Miller cylindrical projection, is given by:

$$∅ = \frac{5}{2} {tan}^{- 1} ( {e}^{\frac{4 x}{5}} ) - \frac{5 π}{8}$$

$$λ = y$$

where ø is latitude and λ is longitude.

Latitude and longitude can be mapped to Cartesian coordinates, with the center of the notional sphere as the origin, via the following equations:

x=R*cos(λ)cos(φ)

y=R*cos(λ)sin(φ)

z=R*sin(λ)

The Miller cylindrical projection is merely one example of a cylindrical projection according to which spherical coordinates can be assigned to pixels at step 408. Other suitable cylindrical projections can also be used, including Mercator, Central Cylindrical, Gall Stereographic, Braun Stereographic, Equidistant and Equal Area projections. The formulas for these projections, and their inversions, are well known and are not repeated here.

Continuing to refer to FIG. 1, at step 410, method 400 can use the spherical coordinates assigned at step 408 to assign colours to image spaces in a spherical image according to a spherical image template. The term “spherical image template”, as used herein, refers to any pixel-based computer-usable image format in which each pixel position in the image corresponds uniquely with a position on the surface of a notional sphere according to a known mapping, and the term “spherical image” refers to a spherical image template whose pixel positions are populated, i.e. colours are assigned to the pixel positions. A system for displaying spherical images or videos, as described below, can use the unique correspondence between each pixel position and a position on the notional sphere to generate a three-dimensional model of a sphere whose surface pixels correspond to those of the spherical image. For example, a user may be presented with a model in which the user's perspective is either inside or outside of the notional sphere, and the user may be permitted to rotate his or her perspective relative to the sphere. The representative method 400 described herein is particularly adapted (although not limited) to using images of the “real world” captured by a high field of view imaging apparatus to generate spherical images. These spherical images or image sequences can then be used to generate immersive environments simulating the “real world” in which the user's perspective is from inside the notional sphere.

In some embodiments, the spherical image template according to which colours are assigned at step 408 can be an equirectangular image template, since the equirectangular projection has a simple relationship between pixel position and the position on the surface of the notional sphere. However, other types of spherical image template may also be used.

Generally, assigning the spherical coordinates to each pixel in each image results in both unique pixels and pixel groups. As used herein, the term “unique pixel” refers to a pixel that has been assigned a unique spherical coordinate, that is, a spherical coordinate that has not been assigned to any other pixel. The term “pixel group”, as used herein, refers to a plurality of pixels whose spherical coordinates are identical, that is, a set of pixels each having been assigned the same spherical coordinates. Where the fields of view of the image sensors are substantially coterminous, there will be very few pixel groups; the number of pixel groups will increase as the degree of overlap between the fields of view of the image sensors increases.

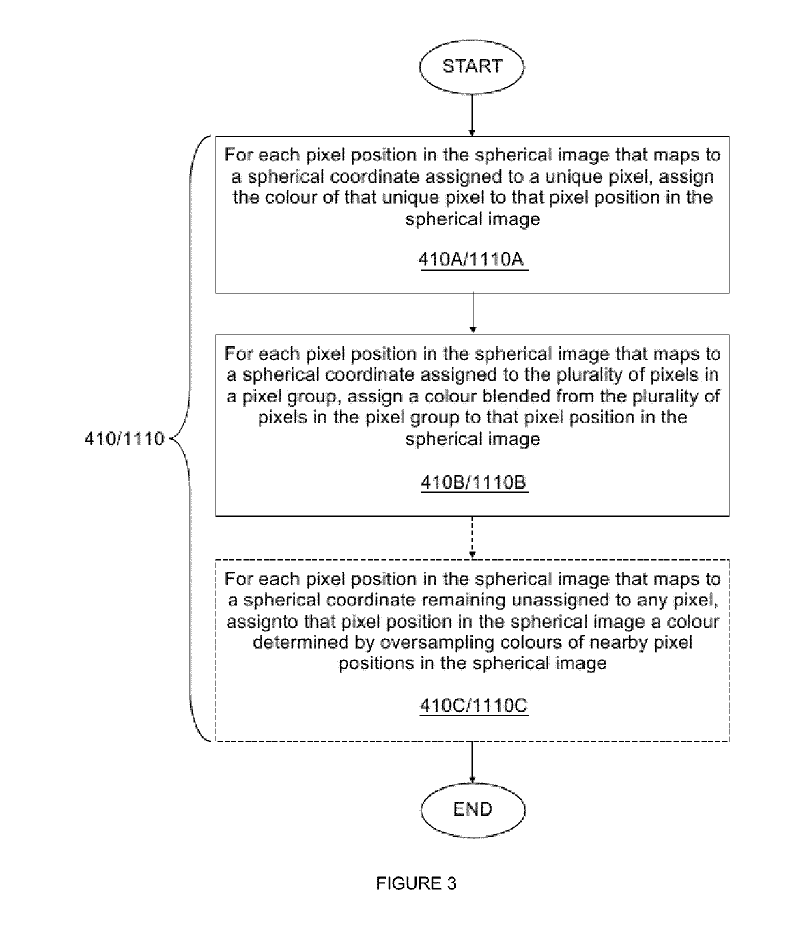

Referring now to FIG. 3, in the case where there are both unique pixels and pixel groups, the step of using the spherical coordinates to assign colours to the pixel positions in the spherical image according to a spherical image template (step 410) can comprise a plurality of sub-steps. At sub-step 410A, for each pixel position in the spherical image that maps to a spherical coordinate assigned to a unique pixel, the colour of that unique pixel can be assigned to that pixel position in the spherical image, and at sub-step 410B, for each pixel position in the spherical image that maps to a spherical coordinate assigned to the plurality of pixels in a pixel group, a colour blended from the plurality of pixels in the pixel group can be assigned to that pixel position in the spherical image. Any suitable blending algorithm now known or hereafter developed may be used for this process.

In addition, there will often be instances in which there is one or more spherical coordinates that remaining unassigned to any pixel. To avoid empty spaces (i.e. blank pixels) in the resulting spherical image, step 410 can include a further optional sub-step 410C of assigning, to each pixel position in the spherical image that maps to a spherical coordinate remaining unassigned to any pixel, a colour determined by oversampling colours of nearby pixel positions in the spherical image template. Steps 410A and 410B can be carried out in any order, or substantially simultaneously, while step 410C could be carried out after steps 410A and 410B so that the pixel positions (other than those to which colours are assigned at sub-step 410C) already have colours assigned to support the oversampling. Any suitable oversampling algorithm now known or hereafter developed can be used for this process; for example, sub-step 410C can comprise bilinear interpolation based on the four closest pixel positions in the spherical image template to the pixel position in the spherical image template to which a colour is being assigned.

Once all of the image frames in the image sequence have been converted spherical images, the spherical image sequence can be saved to a suitable memory storage device as an ordered directory. Each image can be saved as an image file and each image can have an associated timecode. The timecode can be stored in the metadata of the image file. The timecode can also be encoded into the filename of the image file which can be based on a predetermined naming convention. In some embodiments, a manifest file can be provided which can contain information regarding the image sequence. The manifest file can include information such as the filenames which comprise the image sequence, timing information for each frame, frame rate, a description of this image sequence, and various image parameters such as contrast, white balance, colour and other image parameters.

An Audio signal can also be captured in an audio channel either as part of an imaging apparatus or independent therefrom. The audio signal can contain audio timecode information, which can be stored in the metadata of an audio file. The audio signal can then be associated to the spherical image using the timecode information of the image. The audio signal can be stored in a separate file from the image sequence files. The audio signal can be associated to the spherical image sequence by using the timecode information of the images and the audio signal. The manifest file can also indicate whether an audio file is associated with the image sequence and contain the timing information of the audio file such that the audio signal can be associated with the image sequence.

In some embodiments, an equirectangular or other similar spherical video can be converted into a video image sequence. Image files can be generated for each frame of the converted video image sequence. When converting the video to a video image sequence the image sequence can be rendered according to selected parameters such as image quality, frame rate. If audio is present in the spherical video, the audio can be saved as a separate audio file. The image sequence can be saved to a suitable memory storage device as an ordered directory. Each image can have an associated timecode. The timecode can be stored in the metadata of the image frame. The timecode can also be encoded into the filename of the image frame which can be based on a predetermined naming convention. In some embodiments, a manifest file can be provided which can contain information regarding the image sequence. The manifest file can include information such as the filenames which comprise the image sequence, timing information for each frame, frame rate, a description of this image sequence, and various image parameters such as contrast, white balance, colour and other image parameters.

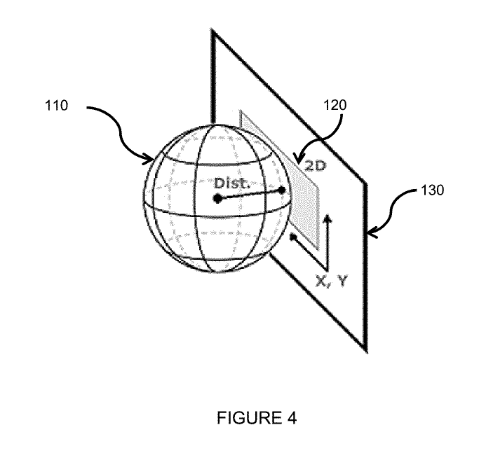

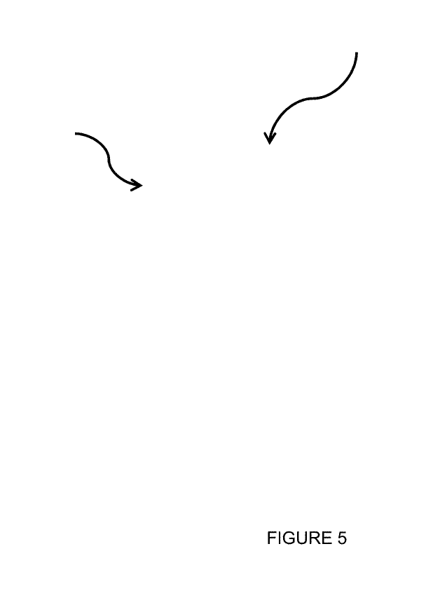

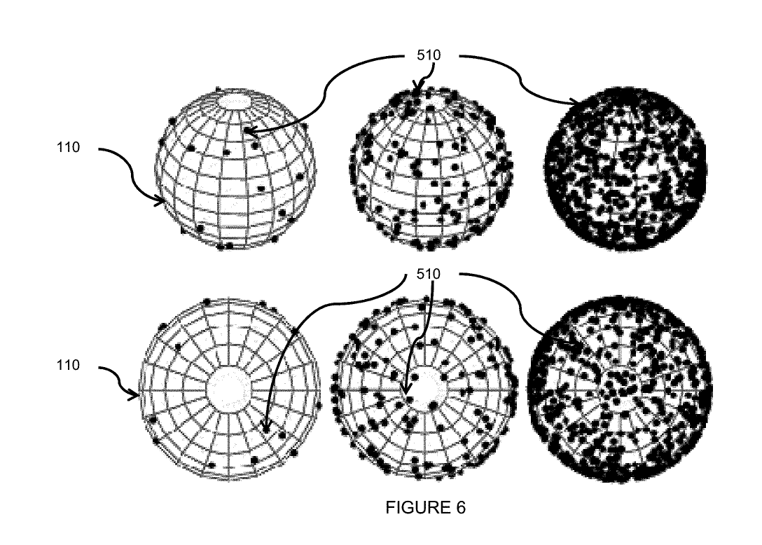

Referring to FIGS. 4 to 6, aspects of an embodiment for a system and method of displaying a spherical image or image sequence are shown. Notional sphere 110 can generated. Notional sphere 110 can then be texturized or canvased with a spherical image or spherical image sequence. Two dimensional area 120 can comprise a portion of the spherical image or spherical image sequence to be displayed in a display window on a display device. Two dimensional area 120 can be sized to resemble standard video aspect ratios such as 16:9 or 4:3. A digital electronic circuit can load the spherical image or spherical image sequence into a computer readable storage medium. In some only a portion of the spherical image or spherical image sequence is loaded into a computer readable storage medium, which can comprise buffering area 130. Buffering area 130 can be larger than two dimensional area 120. Two dimensional area 120 can be repositioned within buffering area 130. As two dimensional area 120 is repositioned within buffering area 130, buffering area 130 can also be repositioned on notional sphere 110 such that two dimensional area 120 remains at or near the centre of buffering area 130.

In some embodiments, the user can reposition two dimensional area 120 on notional sphere 110. The portion of the spherical image or spherical image sequence texturized on notional sphere 110 displayed in a display window on a display device can correspond to the pitch, roll, and yaw coordinates of two dimensional area 120 on notional sphere 110. Two dimensional area can be repositioned based on input from a user. The input can be by way of input keyboard, mouse, touch screen, accelerometer, gyroscope or other input mechanism as is known to one skilled in the art. The position of two dimensional area 120 can be recorded as a function of time. This can create a coordinated view of the spherical image or spherical image sequence over time. This coordinated view can be saved by the user for viewing by other users. The position of the two dimensional area can be saved in a manifest file associated with the spherical image or spherical image sequence. In some embodiments other player options can be saved in the manifest file. The player options can include any additional graphics processing on the frame file such as compressing, colouring, data manipulation, cropping, white balancing, stitching, interlacing, or other forms of editing or optimization known to one skilled in the art. When the spherical image sequence is viewed the player options can be applied to the spherical image or spherical image sequence. Different manifest files can relate to the same spherical image or spherical image sequence. This can allow for different coordinated views to be saved for the same image sequence, or different rendering options to be applied without requiring an additional copy of the spherical image or image sequence. In some embodiments the method and system of displaying spherical image or spherical image sequence can provide options to select parameters and views and save these selections to a new manifest file.

The position of notional sphere 110 can remain constant through time. This can allow reference points 510 on notional sphere 110 to be calculated using pitch, roll, and yaw coordinates. A selected point on notional sphere 110 can be a tag or similar marker on the spherical image or spherical image sequence. The tag can be visible to the user when the position of the tag on notional sphere 110 lies within two dimensional area 120. In some embodiments, a placed object can be placed with a determined orientation on the spherical image or spherical image sequence at reference point 510. As noted, this placed object can be a tag. Additionally the placed object can be an image, video, video sequence, 2D or 3D models or animation sequences. This placed object can be visible in the display window on the display device when the objects position on notional sphere 110 is within two dimensional area 120. The object can also be hyperlinked to additional content. The additional content can comprise but is not limited to other spherical images or spherical image sequences, images, videos, applications, Universal Resource Locator (“URL”) based locations or other interactive content which is selectable by the user when the object's location on notional sphere 110 is within two dimensional area 120. In some embodiments, the data regarding the placed object can be stored in the manifest file related to the

In some embodiments, where a spherical image sequence is texturized on notional sphere 110, the position of objects represented within the spherical image sequence on notional sphere 110 can change over time. One or more reference points 510 can be selected to represent a tracked object within a frame image of the spherical image sequence. A motion tracking algorithm can be used to locate and track the position of the tracked object on notional sphere 110 within each frame image of the spherical image sequence. The position of the tracked object on the notional sphere 110 can be recorded for each frame image of the spherical image sequence. Examples of motion tracking algorithm that can be used are OpenCV™ motion tracking, Open Vision Control™ or combined OpenGL™ and OpenCV™ or other suitable motion tracking algorithm known to one skilled in the art.

In some embodiments, the tracked object can be hyperlinked to additional content in the same manner as described above for the fixed reference points. The additional content can include information about the tracked object. For example, if the tracked object is a consumer product the hyperlink can direct the user to a website to purchase or view more information about the product. A placed object can also be added to the spherical image sequence at the location and orientation of the tracked object. The placed object can be an image, video, video sequence, 2D or 3D models or animation sequences. As an example, a model of a product can be added to the image sequence, or one product can be replaced by another product. This can allow for advertising or product placement which was not contained within the original spherical image sequence.

In some embodiments, object recognition algorithms such as facial recognition and other algorithms as are known to those skilled in the art can be used to identify objects in the spherical image sequence. If an object is recognized in an image of the spherical image sequence, the object can be tracked as described above. In some embodiments, the spherical image sequence can comprise a live feed from a spherical imaging device. The images from the device can be converted to a spherical image sequence as described above. The ordered directory where the images can be saved can be monitored for the presence of a desired object. If the desired object is recognized in the spherical image sequence, a notification can be sent to a user.

In some embodiments, the data regarding the placed objects or tracked objects can be stored in the manifest file related to the spherical image or spherical image sequence. This can comprise all of the information required to display the object on a display device and link to any additional content. This can comprise the position of the object in each image, and the link to the additional content associated with the object

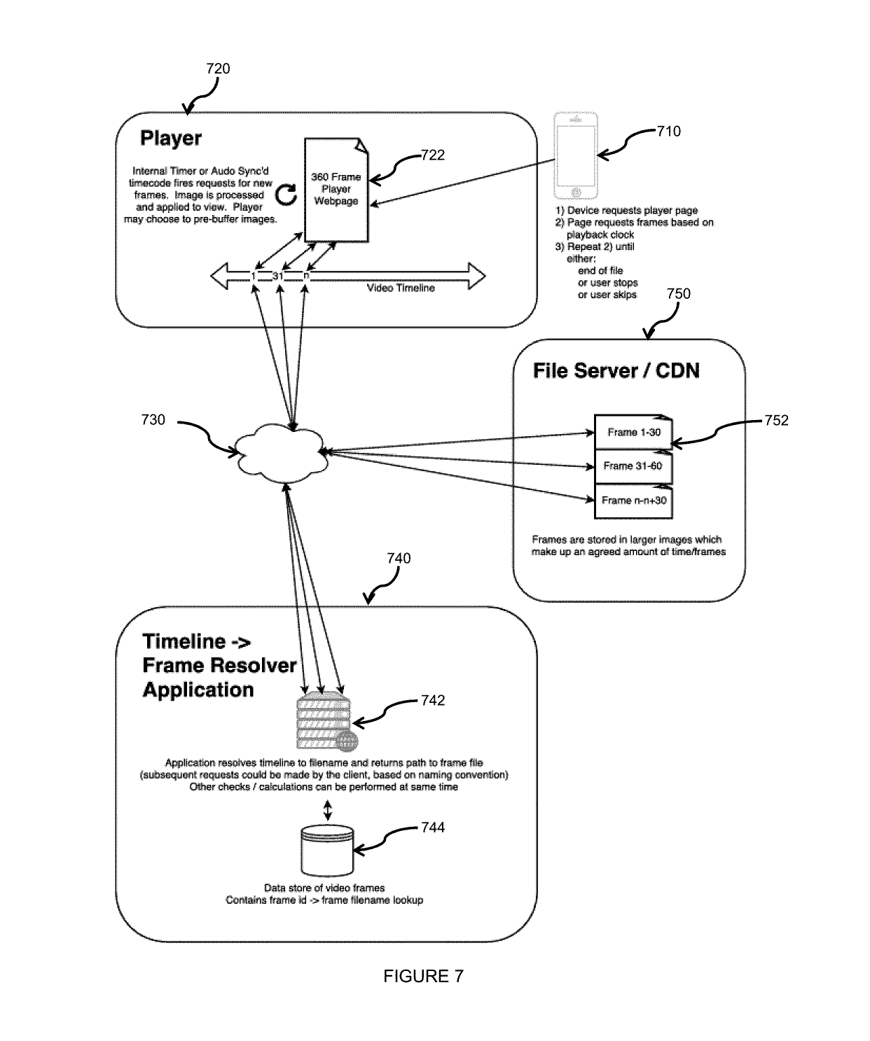

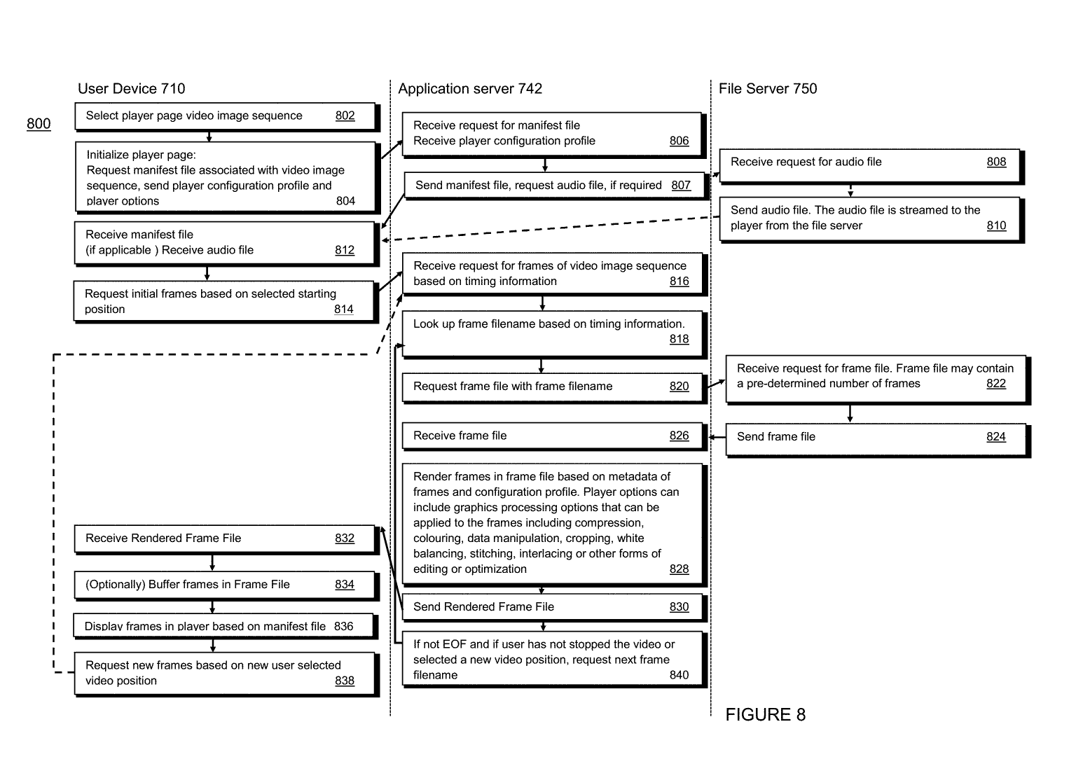

Referring to FIGS. 7 and 8, a system and method for streaming an image sequence is shown. This system and method can stream a video stream comprising an image sequence from a server to a browser without invoking the browser's native playback component. The image sequence can be a spherical image sequence. FIG. 8 is a swim-lane diagram showing representative method 800 for streaming an image sequence. User device 710 can submit a request to play an image sequence to a server. At step 802, user device 710 can open player 720 and request player page 722 which can correspond to a particular image sequence. At step 804, player page 722 can be initialized. The initialization can include requesting a manifest file associated with the video image sequence and sending a configuration profile to the application server 742. The manifest file can include data regarding the image sequence such as the timing information for the image files in the video image sequence, the location the image sequence was created, a description of the image sequence, rendering parameters to be applied to the image sequence such as colour, compression, white balance, and cropping, display setting which can include a coordinated view of the image sequence, i.e. the two dimensional area of each image to display during playback and the aspect ratio. The player configuration profile can include information about user device 710 such as the hardware and software configuration of the device. The manifest file can also include information regarding audio associated with the video image sequence including if audio is required for the playback of the image sequence. At Step 806, the application server 742 can receive the request for the manifest file and receive the player configuration profile. At step 807, application server 742 can send the manifest file to user device 710. In some embodiments the audio can be stored in a separate file from the image sequence and, if required, step 807 can also include requesting an audio file be streamed to user device 710 from file server 750. At optional step 808, file server 750 can receive the request for the audio file and at optional step 810, file server 750 can stream the audio file to user device 710. At step 812, the manifest file can be received from application server 742 and if required the streamed audio file can be progressively downloaded. While in this embodiment the audio file can be downloaded from file server 750, in some embodiments, the audio file can be progressively downloaded from application server 742, or other remote server location. At step 814, Player 720 can request one or more initial frames based on the timing information of an initial starting point representing an initial timecode via network 730 and at step 816 the request can be received by application server 742. At step 818, Timeline to Frame resolver application 740 on application server 742 can query frame data store 744, which can comprise a frame id to frame filename lookup table, to resolve the timecode to frame filename. In some embodiments. At step 820, application server 742 can use the filename path returned by resolver application 740 to request frame file 752 from file server 750. At step 822, file server 750 receives the request for frame file 752 and sends the requested frame file to the application server at step 824. The frame file can comprise a pre-determined number of frames or frames representing a pre-determined amount of time. File server 750 can be the same server as application server 742 or can be a standalone server. Application server 742 can communicate with file server 750 via a communication interface such as inter-process communication, intranet or internet. File server 750 can also comprise a Content Delivery Network (“CDN”) for distributed content distribution. A CDN can be a distributed network of proxy servers where multiple copies of the data can be present on several servers sharing a common CDN hostname. A domain name system (“DNS”) server can resolve the hostname to the internet protocol (“IP”) address of an optimized file server to handle a request.

The application server 742 can receive the requested frame file at step 826 and at step 828 application server 742 can render the frame file based on the manifest file and the player options. The player options can be contained within the manifest file or can be sent to application server 742 separate from the manifest file. The player options can include any additional graphics processing on the frame file such as compressing, colouring, data manipulation, cropping, white balancing, stitching, interlacing, or other forms of editing or optimization known to one skilled in the art.

The processed frame file can then be transferred over network 730 to player 720 at step 830. At step 832, player 720 on user device 710 receives the rendered frame file. In some embodiments, player 720 can be configured to pre-buffer image frames at optional step 834. At step 836, the frames in the rendered frame file can be displayed in player page 722 based on the data in the manifest file which can include a specific time to be allocated to each frame in the rendered frame file or a particular portion of each image to display as a coordinated view of the image sequence. At step 840, if the end of the image sequence has not yet been reached and the user has not stopped the video image sequence or skipped to a new position, Application server 742 can request the next frame filename by looking up the frame filename based on the timing information of the next frame. In some embodiments, the next filename can be requested based on a filename naming convention. At step 838, player 720 can continue to request new frames based on or a new user selected position in the image sequence. In some embodiments player 720 can cache the received rendered frame files and these frames can be displayed without requiring the frames to be resent by the application server.

In some embodiments, the method for streaming a video image sequence can further comprise sending to application server 742 when the display area of player page 722 is visible to the end user. For example, the player can embedded in a webpage and the server can be configured to wait to send the image frame files until the player sends a signal to the server that a sufficient portion of the image sequence player is visible on the display device. Similarly the server can be configured to stop sending frame images if the player sends a signal to the server that the portion of the image sequence player is no longer visible on the display device.

In some embodiments, the system and method for streaming displaying a video image sequence described above can be used to stream a spherical image sequence as described in the method and system for displaying a spherical image or spherical images sequence.

The methods described herein may be implemented on any suitable computer or microprocessor-based system, such as a desktop or laptop computer or a mobile wireless telecommunication computing device, such as a smartphone or tablet computer, which can receive images converted and displayed as described above. The processing of the set of images into a single spherical image can be completed on these off-board devices, either for a single spherical image or a spherical video feed comprising a spherical image sequence. This allows for processing of high-definition video images at standard video frame rate by utilizing computational capabilities of the off-board technology. The computer or microprocessor-based system can be coupled directly to the imaging system with a wired or wireless connection, or may obtain the images from a separate storage medium or network connection such as the Internet.

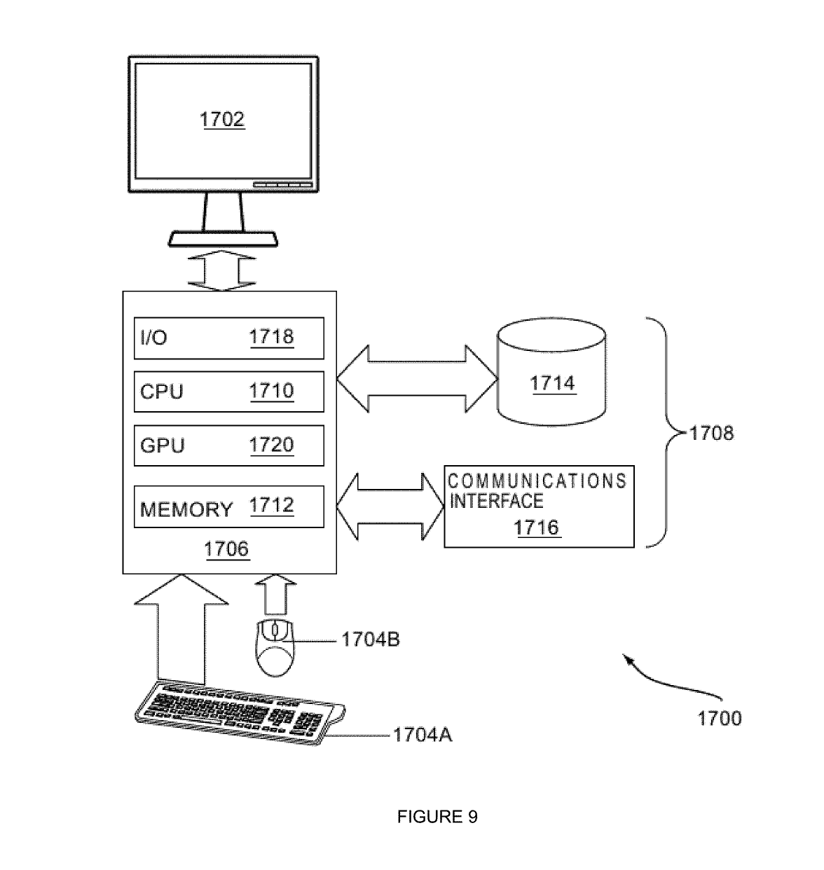

An illustrative computer system in respect of which the methods herein described may be implemented is presented as a block diagram in FIG. 9. The illustrative computer system is denoted generally by reference numeral 1700 and can comprise display 1702, input devices in the form of keyboard 1704A and pointing device 1704B, computer 1706 and external devices 1708. While pointing device 1704B is depicted as a mouse, it will be appreciated that other types of pointing device may also be used.

Computer 1706 can comprise a digital electronic circuit. The digital electronic circuit can comprise one or more processors or microprocessors, FPGAs or ASICs, such as central processing unit (“CPU”) 1710. CPU 1710 can perform arithmetic calculations and control functions to execute software stored in computer-readable storage medium internal memory 1712, which can comprise RAM and/or read only memory (“ROM”), and possibly additional memory 1714. Additional memory 1714 can comprise, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 1714 can be physically internal to computer 1706, or external as shown in FIG. 9, or both.

In some embodiments, computer system 1700 can also comprise other similar means for allowing computer programs or other instructions to be loaded. Such means can include, for example, communications interface 1716 that can allow software and data to be transferred between computer system 1700 and external systems and networks. Examples of communications interface 1716 can comprise a modem, a network interface such as an Ethernet card, a wireless communication interface, or a serial or parallel communications port. Software and data transferred via communications interface 1716 can be in the form of signals which can be electronic, acoustic, electromagnetic, optical or other signals capable of being received by communications interface 1716. Multiple interfaces, of course, can be provided on a single computer system 1700.

In some embodiments, input and output to and from computer 1706 can be administered by input/output (I/O) interface 1718. I/O interface 1718 can administer control of display 1702, keyboard 1704A, external devices 1708 and other such components of computer system 1700. In some embodiments, computer 1706 can also comprise GPU 1720. The latter can also be used for computational purposes as an adjunct to, or instead of, CPU 1710, for mathematical calculations. The various components of computer system 1700 can be coupled to one another either directly or by coupling to suitable buses.

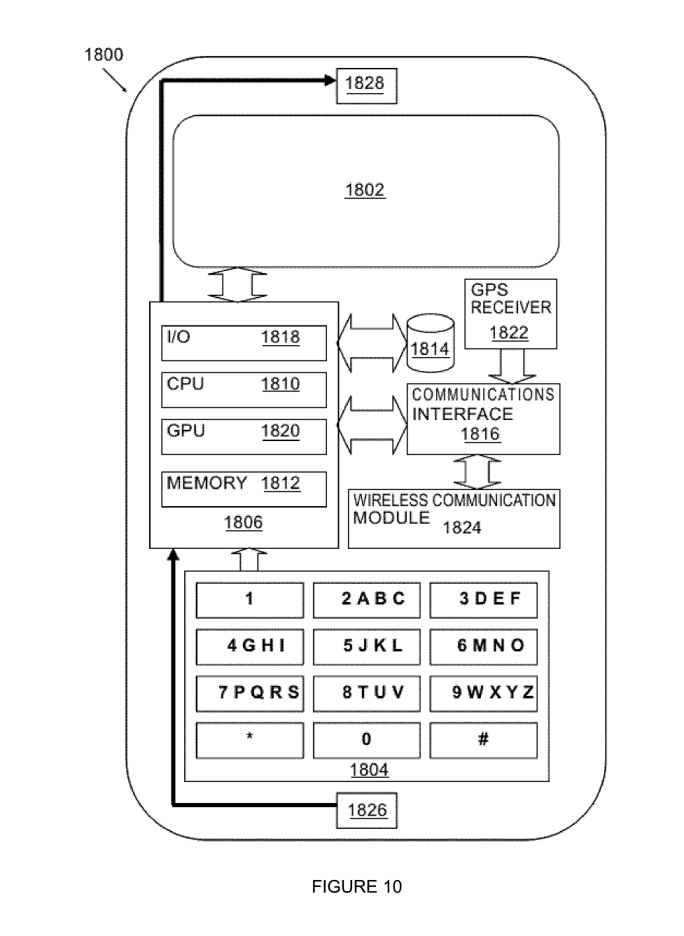

FIG. 10 shows a representative networked mobile wireless telecommunication computing device in the form of smartphone 1800. Smartphone 1800 can comprise display 1802, an input device in the form of keyboard 1804 and onboard computer system 1806. Display 1802 can be a touchscreen display and, thereby, serve as an additional input device or as an alternative to keyboard 1804. Onboard computer system 1806 can comprise a digital electronic circuit, such as CPU 1810 further comprising one or more processors or microprocessors for performing arithmetic calculations and control functions to execute software stored in a computer readable storage medium, such as internal memory 1812, which can comprise RAM and/or ROM and can be coupled to additional memory 1814 which will typically comprise flash memory, which can be integrated into smartphone 1800 or can comprise a removable flash card, or both. Smartphone 1800 can also comprise communications interface 1816 which can allow software and data to be transferred between smartphone 1800 and external systems and networks. In some embodiments, communications interface 1816 can be coupled to one or more wireless communication modules 1824, which will typically comprise a wireless radio for connecting to one or more of a cellular network, a wireless digital network or a Wi-Fi™ network. In some embodiments, communications interface 1816 can also typically enable a wired connection of smartphone 1800 to an external computer system. In some embodiments, microphone 1826 and speaker 1828 can be coupled to onboard computer system 1806 to support the telephone functions managed by the onboard computer system 1806, and GPS receiver hardware 1822 can also be coupled to communications interface 1816 to support navigation operations by onboard computer system 1806. Input and output to and from onboard computer system 1806 can be administered by input/output (“I/O”) interface 1818, which can administer control of display 1802, keyboard 1804, microphone 1826 and speaker 1828. In some embodiments, onboard computer system 1806 can also comprise separate GPU 1820. The various components can be coupled to one another either directly or by coupling to suitable buses.

The methods described herein can be provided as computer program products comprising a computer readable storage medium, such as non-volatile memory, having computer readable program code embodied therewith for executing the method. Thus, the non-volatile memory could contain instructions which, when executed by a processor, cause the computing device to execute the relevant method.

In some embodiments, the above systems and methods can be implemented entirely in hardware, entirely in software, or by way of a combination of hardware and software. In some embodiments, implementation can be by way of software or a combination of hardware and software, which can include but is not limited to firmware, resident software, microcode and the like. In some embodiments, the above systems and methods can be implemented in the form of a computer program product accessible from a computer usable or computer readable medium providing program code for use by or in connection with a computer or any instruction execution system. In such embodiments, the computer program product can reside on a computer usable or computer readable medium in a computer such as memory 1812 of onboard computer system 1806 of smartphone 1800 or memory 1712 of computer 1706, or on a computer usable or computer readable medium external to onboard computer system 1806 of smartphone 1800, or computer 1806, or on any combination thereof.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. A method of displaying at least one spherical image each image comprising a plurality of pixels, the method comprising:
a) generating a notional sphere;
b) receiving the at least one spherical image;
c) associating each pixel of the at least one spherical image with spherical coordinates of the notional sphere;
d) displaying on a display device a two dimensional area of the spherical image, the two dimensional area being associated to a first position on the notional sphere; and
e) repositioning the two dimensional area displayed on the display device within the at least one spherical image to a second position on the notional sphere.

2. The method as set forth in claim 1, wherein the at least one spherical image comprises a video image stream.

3. The method as set forth in claim 1 further comprising the steps of:
a) reading a buffering area being a portion of the spherical image into a computer readable storage medium, the buffering area being an area larger than the two dimensional area; and
b) repositioning the buffering area such that the display such that when the two dimensional area is repositioned the two dimensional area is centred in the buffering area.

4. The method as set forth in claim 1 further comprising the step of recording one or more positions of the display window as a sequence of views to the computer readable storage medium.

5. The method as set forth in claim 1 wherein the repositioning of the two dimensional area is based on a pre-recorded sequence of views of the at least one spherical image.

6. The method as set forth in claim 1 further comprising the steps of:
a) selecting one or more points on the one or more spherical image; and
b) associating and placing a first placed object at the one or more points.

7. The method as set forth in claim 6 wherein the first placed object comprises one or more of a tag, hyperlink, an image, a video, a video image sequence, a two dimensional model, a three dimensional model and an animation sequence.

8. The method as set forth in claim 6 further comprising the step of linking the first placed object to additional content.

9. The method as set forth in claim 8 wherein the additional content comprises one or more of a second spherical image, an application, a linked image, a linked video, a linked video image sequence and a URL based location.

10. The method set forth in claim 1 further comprising the step of displaying a previously placed object which is associated with a point on the notional sphere within the display area.

11. The method set forth in claim 6 further comprising the steps of:
a) tracking the position of the one or more points in the one or more spherical image in each of the one or more spherical images, the one or more points representing a tracked object; and
b) recording the position of the tracked object in each of the one or more spherical images in relation to the notional sphere.

12. The method as set forth in claim 11 wherein the position of the first placed object corresponds to the position of the tracked object in each of the one or more spherical images.

13. A computer system for displaying at least one spherical image each image comprising a plurality of pixels, the computer system comprising:
a) a digital electronic circuit;
b) a display device; and
c) at least one computer-readable storage medium operatively coupled to the digital electronic circuit, said at least one computer-readable storage medium containing a representation of at least one set of computer instructions that, when executed by said digital electronic circuit, causes the computer system to perform the operations of:
i) generating a notional sphere,
ii) receiving the at least one spherical image,
iii) associating each pixel of the at least one spherical image with spherical coordinates of the notional sphere,
iv) displaying, on the display device, a two dimensional area of the spherical image, the two dimensional area being associated to a first position on the notional sphere, and
v) repositioning the two dimensional area displayed on the display device within the at least one spherical image area to a second position on the notional sphere.

14. The system as set forth in claim 13, wherein the digital electronic circuit comprises one or more of a processor, a FPGA and an ASIC.

15. The system as set forth in claim 13, wherein the at least one spherical image comprises a video image stream.

16. The system as set forth in claim 13 wherein the digital electronic circuit executes the at least one set of instructions to cause the computer system to further perform the operations of
a) reading a buffering area being a portion of the spherical image into a computer readable storage medium, the buffering area being an area larger than the two dimensional area; and
b) repositioning the buffering area such that the display such that when the two dimensional area is repositioned the two dimensional area is centred in the buffering area.

17. The system as set forth in claim 13 wherein the digital electronic circuit executes the at least one set of instructions to cause the computer system to further perform the operation of recording one or more positions of the display window as a sequence of views to the computer readable storage medium.

18. The system as set forth in claim 13 wherein the operation of repositioning the two dimensional area is based on a pre-recorded sequence of views of the at least one spherical image.

19. The system as set forth in claim 13 wherein the digital electronic circuit executes the at least one set of instructions to cause the computer system to further perform the operations of:
a) selecting one or more points on the one or more spherical image on the notional sphere; and
b) associating and placing a first placed object at the one or more points.

20. The system as set forth in claim 19 wherein the first placed object comprises one or more of a tag, hyperlink, an image, a video, a video image sequence, a two dimensional model, a three dimensional model, and an animation sequence.

21. The system as set forth in claim 19 wherein the digital electronic circuit executes the at least one set of instructions to cause the computer system to further perform the operation of linking the first placed object to additional content.

22. The system as set forth in claim 21 wherein the additional content comprises one or more of a second spherical image, an application, a linked image, a linked video, a linked video image sequence and a URL based location.

23. The system set forth in claim 13 wherein the digital electronic circuit executes the at least one set of instructions to cause the computer system to further perform the operation of displaying a previously placed object which is associated with a point on the notional sphere within the display area.

24. The system set forth in claim 19 wherein the digital electronic circuit executes the at least one set of instructions to cause the computer system to further perform the operations of:
a) tracking the position of the one or more points in the one or more spherical image in each of the one or more spherical images, the one or more points representing a tracked object; and
b) recording the position of the tracked object in each of the one or more spherical images in relation to the notional sphere.

25. The system set forth in claim 24 wherein the digital electronic circuit executes the at least one set of instructions to cause the computer system to further perform the operations of associating and placing the first placed object at the position of the tracked object in each of the one or more spherical images.

26. A method for converting a high field of view video from at least one camera into a spherical image sequence, the method comprising the steps of:
a) deriving at least one image from the camera each image comprising a plurality of pixels, each image having an image timecode, wherein the at least one image defines an image plane representing a field of view from a unique point along an optical axis that is substantially perpendicular to the image plane;
b) assigning a spherical coordinate on a notional sphere to each pixel in the at least one image according to a cylindrical projection aligned with the image plane for the at least one image;
c) using the spherical coordinates to assign colours derived from the pixels to pixel positions in a spherical image according to a spherical image template, wherein the notional sphere is substantially centred on the unique point, and the image plane of the at least one image is substantially tangential to the notional sphere, and wherein the cylindrical projection is aligned with the image plane for the at least one image by a notional cylinder of the cylindrical projection having its cylinder wall substantially tangential to the image plane and its longitudinal axis intersecting the unique point along the optical axis; and
d) storing each of the at least one images as an ordered directory in a computer readable storage medium.

27. The method as set forth in claim 26, further comprising the steps of:
a) capturing an audio signal in an audio channel the audio signal having a an audio timecode sequence; and
b) associating the audio signal with the spherical image sequence by comparing the image timecode with the audio timecode sequence.

28. A computer system for converting a high field of view video from at least one camera into a spherical image sequence, the computer system comprising:
a) a digital electronic circuit;
b) at least one computer-readable storage medium operatively coupled to the digital electronic circuit, said at least one computer-readable storage medium containing a representation of at least one set of computer instructions that, when executed by said digital electronic circuit, causes the computer system to perform the operations of:
i) deriving at least one image from the camera each image comprising a plurality of pixels, each image having an image timecode, wherein the at least one image defines an image plane representing a field of view from a unique point along an optical axis that is substantially perpendicular to the image plane,
ii) assigning a spherical coordinate on a notional sphere to each pixel in the at least one image according to a cylindrical projection aligned with the image plane for the at least one image,
iii) using the spherical coordinates to assign colours derived from the pixels to pixel positions in a spherical image according to a spherical image template, wherein the notional sphere is substantially centred on the unique point, and the image plane of the at least one image is substantially tangential to the notional sphere, and wherein the cylindrical projection is aligned with the image plane for the at least one image by a notional cylinder of the cylindrical projection having its cylinder wall substantially tangential to the image plane and its longitudinal axis intersecting the unique point along the optical axis, and
iv) storing each of the at least one images as an ordered directory in the computer-readable storage medium.

29. The system as set forth in claim 28, wherein the digital electronic circuit comprises one or more of a processor, FPGA, and ASIC.

30. The system as set forth in claim 28, wherein the digital electronic circuit executes the at least one set of instructions to cause the computer system to further perform the operations of:
a) capturing an audio signal in an audio channel the audio signal having a an audio timecode sequence; and
b) associating the audio signal with the spherical image sequence by comparing the image timecode with the audio timecode sequence.

31. A method of streaming a video image sequence comprising a plurality of frame images from at least one server, the method comprising:
a) selecting the video image sequence for viewing on a display device;
b) requesting, via a communication interface, at least one frame image file based on timing information, each frame image file comprising at least one of the plurality of frame images,
c) receiving, from the at least one server, the at least one frame image file;
d) displaying, on the display device, the at least one frame image of the frame image file as a video;
e) receiving subsequent frame image files from the at least one server; and
f) displaying, on the display device, the frame images of the subsequent frame image files.

32. The method as set forth in claim 31 further comprising the steps of downloading a manifest file which contains the timing information.

33. The method as set forth in claim 31 further comprising the steps of
a) receiving the audio signal file from the one or more server as a progressive download; and
b) playing the audio signal file based on coordinated timing information with the frame images.

34. The method as set forth in claim 31 further comprising the step of buffering the at least one image file prior to displaying the frame images on the display device.

35. The method as set forth in claim 31 further comprising the step of caching the at least one image file and the subsequent frame image files for displaying the images on the frame images on the display device.

36. A computer system for streaming a video image sequence comprising a plurality of frame images from at least one server, the computer system comprising:
a) a digital electronic circuit;
b) a display device;
c) a communication interface; and
d) at least one computer-readable storage medium operatively coupled to the digital electronic circuit, said at least one computer-readable storage medium containing a representation of at least one set of computer instructions that, when executed by said digital electronic circuit, causes the computer system to perform the operations of:
i) selecting the video image sequence for viewing on a display device,
ii) requesting, via the communication interface, at least one frame image file based on timing information, each frame image file comprising at least one of the plurality of frame images,
iii) receiving, from the at least one server, the at least one frame image file,
iv) displaying, on the display device, the at least one frame image of the frame image file as a video,
v) receiving subsequent frame image files from the at least one server, and
vi) displaying, on the display device, the frame images of the subsequent frame image files.

37. The system as set forth in claim 36, wherein the digital electronic circuit comprises one or more of a processor, a FPGA and an ASIC.

38. The system as set forth in claim 36, further comprising an audio output device, and wherein the digital electronic circuit executes the at least one set of instructions to cause the computer system to further perform the operations of:
a) receiving the audio signal file from the one or more server as a progressive download; and
b) playing the audio signal file, via the audio output device, based on coordinated timing information with the frame images.

39. The system as set forth in claim 36, wherein the digital electronic circuit executes the at least one set of instructions to cause the computer system to further perform the operation of buffering the at least one image file prior to displaying the frame images on the display device.

40. The system as set forth in claim 36, wherein the digital electronic circuit executes the at least one set of instructions to cause the computer system to further perform the operation of caching the at least one image file and the subsequent frame image files for displaying the images on the frame images on the display device.

41. The system as set forth in claim 36, wherein the digital electronic circuit executes the at least one set of instructions to cause the computer system to further perform the operation of downloading a manifest file which contains the timing information.

42. A method of streaming a video image sequence comprising a plurality of frame images to a user device, the method comprising:
a) receiving a request from the user device for a frame image file, the frame image file comprising at least one of the frame images, based on timing information;
b) rendering the frame images of the frame image file based on a manifest file and saving a rendered frame image file to the computer readable storage medium;
c) transferring, to the user device, the rendered frame image file;
d) rendering frame images of subsequent frame image files based on the manifest file and saving subsequent rendered frame image files to the computer readable storage medium; and
e) transferring, to the user device, the subsequent rendered frame image files.

43. The method as set forth in claim 42 wherein the frame image file comprises pre-rendered frames.

44. The method as set forth in claim 42 further comprising the steps of:
a) retrieving a frame image filename associated with the timing information from a data store; and
b) retrieving the frame image file associated with the frame image filename from a file server.

45. The method as set forth in claim 44 wherein the file server comprises a content delivery network.

46. The method as set forth in claim 42 further comprising the step of transferring an audio signal file to the user device as a progressive download.

47. The method as set forth in claim 42 wherein the rendering of the frame images further comprises reading rendering parameters from the manifest file.

48. A computer system for streaming a video image sequence comprising a plurality of frame images to a user device, the computer system comprising:
a) a digital electronic circuit;
b) at least one computer-readable storage medium operatively coupled to the digital electronic circuit, said at least one computer-readable storage medium containing a representation of at least one set of computer instructions that, when executed by said digital electronic circuit, causes the computer system to perform the operations of:
i) receiving a request from the user device for a frame image file, the frame image file comprising at least one of the frame images, based on timing information,
ii) rendering the frame images of the frame image file based on a manifest file and saving a rendered frame image file to the computer readable storage medium,
iii) transferring, to the user device, the rendered frame image file;
iv) rendering frame images of subsequent frame image files based on the manifest file and saving subsequent rendered frame image files to the computer readable storage medium, and
v) transferring, to the user device, the subsequent rendered frame image files.

49. The system as set forth in claim 48, wherein the digital electronic circuit comprises one or more of a processor, a FPGA and an ASIC.

50. The system as set forth in claim 48, wherein the frame image file comprises pre-rendered frames.

51. The system as set forth in claim 48, wherein the digital electronic circuit executes the at least one set of instructions to cause the computer system to further perform the operations of:
a) retrieving a frame image filename associated with the timing information from a data store; and
b) retrieving the frame image file associated with the frame image filename from a file server.

52. The system as set forth in claim 51 wherein the file server comprises a content delivery network.

53. The system as set forth in claim 48, wherein the digital electronic circuit executes the at least one set of instructions to cause the computer system to further perform the operation of transferring an audio signal file to the user device as a progressive download.

54. The system as set forth in claim 48, wherein the rendering of the frame images further comprises reading rendering parameters from the manifest file.
